(19) United States
(12) Patent Application Publication
(10) Pub. No.: US 2024/0132675 A1
(43) Pub. Date: Apr. 25, 2024

(54) POLYMER HAVING METAL-OXYGEN-METAL BOND AS PRIMARY CHAIN, COMPOSITION THEREOF, SOLID MATERIAL AND PRODUCTION METHOD THEREOF, AND ELECTRONIC COMPONENT AND FIBER

(71) Applicant: Toray Industries, Inc., Tokyo (JP)

(72) Inventors: Masao Kamogawa, Otsu-shi, Shiga (JP); Mitsuhito Suwa, Otsu-shi, Shiga (JP); Yuki Shigemizu, Otsu-shi, Shiga (JP)

(73) Assignee: Toray Industries, Inc., Tokyo (JP)

(21) Appl. No.: 18/276,928

(22) PCT Filed: Mar. 11, 2022
(86) PCT No.: PCT/JP2022/010857

§ 371 Date: Aug. 11, 2023

(30) Foreign Application Priority Data
Mar. 22, 2021 (JP) 2021-046841

(51) Int. Cl. C08G 79/00; C09D 185/00; D01F 1/10; D01F 9/10

(52) U.S. Cl. CPC C08G 79/00; C09D 185/00; D01F 1/10; D01F 9/10

(57) ABSTRACT

A polymer including, as the main chain, a metal-oxygen-metal bond including a structural unit represented by the following general formula (1): wherein M represents a metal atom selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi; R¹ is selected from a hydrogen atom, a C₁-C₈ alkyl group, a C₁-C₈ alkylcarbonyl group, a C₆-C₁₂ aryl group, a C₇-C₁₃ aralkyl group, a (R⁵₃Si-group, a (R⁶R⁷N—) group, a 4-oxopent-2-en-2-yl group, a C₅-C₁₂ 4-alkoxy-4-oxobuta-2-en-2-yl group, and a C₁₀-C₁₆ 4-aryloxy-4-oxobuta-2-en-2-yl group; R² and R³ are each independently a hydrogen atom or a C₁-C₈ alkyl group; R⁴ is a hydrogen atom, a C₁-C₈ alkyl group, or a C₁-C₈ alkylcarbonyl group; R⁵ is a hydroxy group, a C₁-C₈ alkyl group, a C₅-C₁₂ alicyclic alkyl group, a C₁-C₁₂ alkoxy group, a C₆-C₁₂ aryl group, a C₇-C₁₃ aralkyl group, or a group having a siloxane bond; a plurality of R⁵ may be the same or different; R⁶ and R⁷ are each independently a hydrogen atom, a C₁-C₈ alkyl group, a C₅-C₁₂ alicyclic alkyl group, a C₆-C₁₂ aryl group, a C₇-C₁₃ aralkyl group, or a C₁-C₁₂ acyl group; R⁶ and R⁷ may be linked via a carbon-carbon saturated bond or a carbon-carbon unsaturated bond to form a ring structure; m is an integer that represents the valence of the metal atom M; a is an integer of 1 to (m−2); and b is an integer of 1 to 6, and c is an integer of 1 to 5. Provided is a polymer including a metal-oxygen-metal bond as the main chain that is stably present without aggregating or turning into a gel even in high concentration and high viscosity.

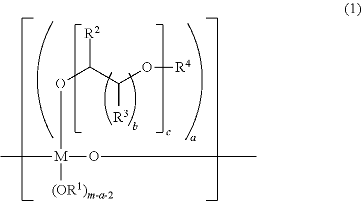

### CROSS REFERENCE TO RELATED APPLICATIONS

This is the U.S. National Phase application of PCT/JP2022/010857, filed Mar. 11, 2022, which claims priority to Japanese Patent Application No. 2021-046841, filed Mar. 22, 2021, the disclosures of each of these applications being incorporated herein by reference in their entireties for all purposes.

### FIELD OF THE INVENTION

The present invention relates to a polymer including a metal-oxygen-metal bond as the main chain, a composition thereof, a solid material and a method for producing the same, and an electronic component and a fiber including the same.

### BACKGROUND OF THE INVENTION

Metal oxides have properties such as high heat resistance, high transparency, and high refractive index, and they are expected to have properties useful for various applications when formed into a film or a fiber.

Examples of a known method of forming a film made of such a metal oxide includes a method of forming a film of titanium oxide or zirconium oxide by a gas-phase process such as chemical vapor deposition (CVD). With a gas phase process such as CVD, however, a film formation rate is low, and it is difficult to obtain a metal oxide film with an industrially usable film thickness.

On the other hand, there has been proposed a method of obtaining a thin film having high heat resistance, high transparency, and high refractive index by applying a solution of a polymer including a metal-oxygen-metal atom bond as the main chain (hereinafter, polymetalloxane) and curing the solution. Such a polymetalloxane may be obtained by hydrolyzing a metal alkoxide and polycondensing the hydrolyzed metal alkoxide. However, hydrolyzing a metal alkoxide typically causes the resulting hydrolysates to aggregate and become insoluble in a solvent. Thus, required is a polymetalloxane that is present stably in a uniform state in a solution and can form a homogeneous cured film.

Reported in a past literature is to introduce a specific substituent into a side chain of a polymer to enable a polymetalloxane to be present stably in a uniform state in a solution (see Patent Document 1, for example).

### PATENT DOCUMENT

Patent Document 1: International Publication No. 2017/90512

### SUMMARY OF THE INVENTION

In a method described in Patent Literature 1, having a side chain that is a specific group, such as a trialkylsiloxy group, makes it possible to obtain a polymetalloxane that can be present stably in a uniform state in a solution. Such a polymetalloxane is obtained, for example, by using a compound obtained by reacting a trialkylsilanol with a metal alkoxide as a raw material. However, a solution of such a polymetalloxane, rapidly increasing its viscosity and turning into a gel with a high concentration, has a problem in industrial stable supply.

An object of the present invention is to provide a polymetalloxane that is present stably without aggregating or turning into a gel even in high concentration and high viscosity.

The present invention is a polymer including, as the main chain, a metal-oxygen-metal bond including a structural unit represented by the following general formula (1):

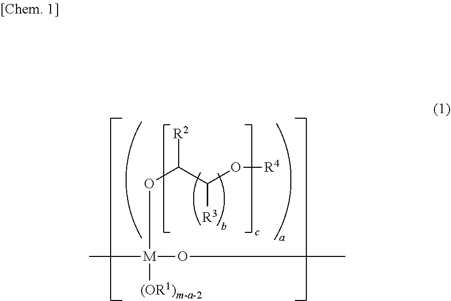

M represents a metal atom selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi;
R¹ is selected from a hydrogen atom, a C₁-C₈ alkyl group, a C₁-C₈ alkylcarbonyl group, a C₆-C₁₂ aryl group, a C₇-C₁₃ aralkyl group, a (R⁵₃Si—) group, a (R⁶R⁷N—) group, a 4-oxopent-2-en-2-yl group, a C₅-C₁₂ 4-alkoxy-4-oxobuta-2-en-2-yl group, and a C₁₀-C₁₆ 4-aryloxy-4-oxobuta-2-en-2-yl group;
R² and R³ are each independently a hydrogen atom or a C₁-C₈ alkyl group;
R⁴ is a hydrogen atom, a C₁-C₈ alkyl group, or a C₁-C₈ alkylcarbonyl group;
R⁵ is a hydroxy group, a C₁-C₈ alkyl group, a C₅-C₁₂ alicyclic alkyl group, a C₁-C₁₂ alkoxy group, a C₆-C₁₂ aryl group, a C₇-C₁₃ aralkyl group, or a group having a siloxane bond; a plurality of R⁵ may be the same or different;
R⁶ and R⁷ are each independently a hydrogen atom, a C₁-C₈ alkyl group, a C₅-C₁₂ alicyclic alkyl group, a C₆-C₁₂ aryl group, a C₇-C₁₃ aralkyl group, or a C₁-C₁₂ acyl group; R⁶ and R⁷ may be linked via a carbon-carbon saturated bond or a carbon-carbon unsaturated bond to form a ring structure;
m is an integer that represents the valence of the metal atom M;
a is an integer of 1 to (m−2); and
b is an integer of 1 to 6, and c is an integer of 1 to 5.

The polymer including the metal-oxygen-metal bond as the main chain of the present invention is present stably in a transparent and uniform state in a high-viscosity and high-concentration solution, and it has excellent storage stability.

### DETAILED DESCRIPTION OF EMBODIMENTS OF THE INVENTION

The present invention according to exemplary embodiments is a polymer including, as the main chain, a metal-oxygen-metal bond including a structural unit represented by the following general formula (1) (hereinafter referred to as “polymetalloxane”).

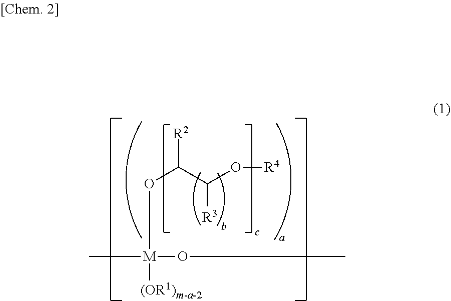

M represents a metal atom selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi.
R¹ is selected from a hydrogen atom, a C₁-C₈ alkyl group, a C₁-C₈ alkylcarbonyl group, a C₆-C₁₂ aryl group, a C₇-C₁₃ aralkyl group, a (R⁵₃Si—) group, a (R⁶R⁷N—) group, a 4-oxopent-2-en-2-yl group, a C₅-C₁₂ 4-alkoxy-4-oxobuta-2-en-2-yl group, and a C₁₀-C₁₆ 4-aryloxy-4-oxobuta-2-en-2-yl group.
R² and R³ are each independently a hydrogen atom or a C₁-C₈ alkyl group.
R⁴ is a hydrogen atom, a C₁-C₈ alkyl group, or a C₁-C₈ alkylcarbonyl group.
R⁵ is a hydroxy group, a C₁-C₈ alkyl group, a C₅-C₁₂ alicyclic alkyl group, a C₁-C₁₂ alkoxy group, a C₆-C₁₂ aryl group, a C₇-C₁₃ aralkyl group, or a group having a siloxane bond. A plurality of R⁵ may be the same or different.
R⁶ and R⁷ are each independently a hydrogen atom, a C₁-C₈ alkyl group, a C₅-C₁₂ alicyclic alkyl group, a C₆-C₁₂ aryl group, a C₇-C₁₃ aralkyl group, or a C₁-C₁₂ acyl group. R⁶ and
R⁷ may be linked via a carbon-carbon saturated bond or a carbon-carbon unsaturated bond to form a ring structure.
m is an integer that represents the valence of the metal atom M.
a is an integer of 1 to (m−2).
b is an integer of 1 to 6, and c is an integer of 1 to 5.

Specific examples of the C₁-C₈ alkyl group include a methyl group, an ethyl group, a propyl group, an isopropyl group, a butyl group, an isobutyl group, an s-butyl group, a t-butyl group, a pentyl group, a hexyl group, a heptyl group, an octyl group, and a 2-ethylhexyl group.

Specific examples of the C₁-C₈ alkylcarbonyl group include a methylcarbonyl group, an ethylcarbonyl group, a propylcarbonyl group, an isopropylcarbonyl group, a butylcarbonyl group, an isobutylcarbonyl group, an s-butylcarbonyl group, a t-butylcarbonyl group, a pentylcarbonyl group, a hexylcarbonyl group, a heptylcarbonyl group, an octylcarbonyl group, and a 2-ethylhexylcarbonyl group.

Specific examples of the C₆-C₁₂ aryl group include a phenyl group and a naphthyl group.

Specific examples of the C₇-C₁₃ aralkyl group include a benzyl group and a phenethyl group.

Specific examples of the C₅-C₁₂ alicyclic alkyl group include a cyclopentyl group, a cyclohexyl group, a cycloheptyl group, a cyclooctyl group, a cyclononyl group, and a cyclodecyl group.

Specific examples of the C₁-C₁₂ alkoxy group include a methoxy group, an ethoxy group, a propoxy group, an isopropoxy group, a butoxy group, an isobutoxy group, an s-butoxy group, a t-butoxy group, a pentoxy group, a hexyloxy group, a heptoxy group, an octoxy group, a 2-ethylhexyloxy group, a nonyl group, and a desiloxy group.

The group having a siloxane bond refers to a group bonded to another Si via an oxygen atom.

Specific examples of the (R⁵₃Si—) group include a trihydroxysilyl group, a trimethylsilyl group, a triethylsilyl group, a tripropylsilyl group, a triisopropylsilyl group, a tributylsilyl group, a triisobutylsilyl group, a tri-s-butylsilyl group, a tri-t-butylsilyl group, a tricyclohexylsilyl group, a trimethoxysilyl group, a triethoxysilyl group, a tripropoxysilyl group, a triisopropoxysilyl group, a tributoxysilyl group, a triphenylsilyl group, a hydroxydiphenylsilyl group, a methyldiphenylsilyl group, an ethyldiphenylsilyl group, a propyldiphenylsilyl group, a dihydroxy(phenyl)silyl group, a dimethyl(phenyl)silyl group, a diethyl(phenyl)silyl group, a dipropyl(phenyl)silyl group, a trinaphthylsilyl group, a hydroxydinaphthylsilyl group, a methyldinaphthylsilyl group, an ethyldinaphthylsilyl group, a propyldinaphthylsilyl group, a dihydroxy(naphthyl)silyl group, a dimethyl(naphthyl)silyl group, a diethyl(naphthyl)silyl group, and dipropyl(naphthyl)silyl group.

Specific examples of the (R⁶R⁷N—) group include an N-succinimidyl group, an N-phthalimidyl group, an N-(5-norbornene-2,3-dicarboxyimidyl) group, an N—(N′-hydroxypyromellitimidyl)oxy group, an N-(1,8-naphthalimidyl) group, and an N—(N′-hydroxy-1,2,3,4-cyclobutanetetracarboxylic acid diimidyl) group.

Specific examples of the C₅-C₁₂ 4-alkoxy-4-oxobuta-2-en-2-yl group include a 4-methoxy-4-oxobuta-2-en-2-yl group, a 4-ethoxy-4-oxobuta-2-en-2-yl group, a 4-propoxy-4-oxobuta-2-en-2-yl group, and a 4-butoxy-4-oxobuta-2-en-2-yl group.

Specific examples of the C₁₀-C₁₆ 4-aryloxy-4-oxobuta-2-en-2-yl group include a 4-phenyloxy-4-oxobuta-2-en-2-yl group and a 4-naphthyloxy-4-oxobuta-2-en-2-yl group.

Specific examples of the C₁-C₁₂ acyl group include a formyl group, an acetyl group, a trifluoroacetyl group, a phenylacetyl group, a propionyl group, and a benzoyl group.

The polymetalloxane is a polymer including a metal-oxygen-metal bond as the main chain. The metal atom M constituting the polymetalloxane in embodiments of the present invention is selected from the group consisting of Al, Sc, Ti, V, Cr, Mn, Fe, Co, Ni, Cu, Zn, Ga, Ge, Y, Zr, Nb, Mo, Pd, Ag, In, Sn, Sb, Hf, Ta, W, and Bi. Containing these metal atoms makes it possible to obtain a cured film and a metal oxide fiber having high heat resistance.

In the polymetalloxane of the present invention, M preferably contains one or more metal atoms selected from the group consisting of Al, Ti, Zr, and Sn. Containing these metal atoms makes it possible to obtain a polymetalloxane having high refractive index.

The polymetalloxane containing the repeating structural unit represented by the general formula (1), having a structure of a part bracketed by ( )ₐ in the general formula (1), has a remarkably improved compatibility with other components. Thus, the polymetalloxane is present stably in a solvent. Therefore, the polymetalloxane is present stably in a transparent and uniform state in a high-viscosity and high-concentration solution, and the solution has excellent storage stability. In addition, since the condensation stress is relaxed in the step of forming a cured film or metal oxide fiber to be described later, a homogeneous cured film or metal oxide fiber in which cracks are hardly generated can be obtained.

The bond between the structure of the part bracketed by ( )ₐ and the metal atom M in the polymetalloxane main chain has strong ionic bondability because there is a large difference in electronegativity between the oxygen atom O and the metal atom M. However, since the structure of the part bracketed by ( )ₐ has an ether group (—O—), and the ether group acts as an electron withdrawing group and disperses the negative charge of O directly bonded to the metal atom M in the polymetalloxane main chain. Thus, the bond between the structure of the part bracketed by ( )ₐ and the metal atom M in the polymetalloxane main chain can be present stably. Further, the ether group in the structure of the part bracketed by ( )ₐ causes electrostatic interaction with the metal atom contained in the main chain of the polymetalloxane. Thus, an effect of inhibiting the nucleophilic reaction of water or a hydroxyl group present in a polymetalloxane solution to the metal atom in the main chain of the polymetalloxane is achieved. From the above, the polymetalloxane having the structure of the part bracketed by ( )ₐ has high storage stability.

Specific examples of the structure of the part bracketed by ( )ₐ include a 2-methoxyethoxy group, a 3-methoxypropoxy group, a 4-methoxybutoxy group, a 5-methoxyhexyloxy group, a (1-methoxypropan-2-yl)oxy group, a 2-methoxypropoxy group,
a 2-ethoxyethoxy group, a 3-ethoxypropoxy group, a 4-ethoxybutoxy group, a 5-ethoxyhexyloxy group, a (1-ethoxypropan-2-yl)oxy group, a 2-ethoxypropoxy group,
a 2-propoxyethoxy group, a 3-propoxypropoxy group, a 4-propoxybutoxy group, a 5-propoxyhexyloxy group, a (1-propoxypropan-2-yl)oxy group, a 2-propoxypropoxy group,
a 2-butoxyethoxy group, a 3-butoxypropoxy group, a 4-butoxybutoxy group, a 5-butoxyhexyloxy group, a (1-butoxypropan-2-yl)oxy group, a 2-butoxypropoxy group,
a 2-(2-methoxyethoxy)ethoxy group, a 3-(3-methoxypropoxy)propoxy group, a 4-(4-methoxybutoxy)butoxy group, a 5-(5-methoxyhexyloxy)hexyloxy group, a (1-((1-methoxypropan-2-yl)oxy)propan-2-yl)oxy group, a 2-(2-methoxypropoxy)propoxy group,
a 2-(2-ethoxyethoxy)ethoxy group, a 3-(3-ethoxypropoxy)propoxy group, a 4-(4-ethoxybutoxy)butoxy group, a 5-(5-ethoxyhexyloxy)hexyloxy group, a (1-((1-ethoxypropan-2-yl)oxy)propan-2-yl)oxy group, a 2-(2-ethoxypropoxy)propoxy group,
a 2-(2-propoxyethoxy)ethoxy group, a 3-(3-propoxypropoxy)propoxy group, a 4-(4-propoxybutoxy)butoxy group, a 5-(5-propoxyhexyloxy)hexyloxy group, a (1-((1-propoxypropan-2-yl)oxy)propan-2-yl)oxy group, a 2-(2-propoxypropoxy)propoxy group,
a 2-(2-butoxyethoxy)ethoxy group, a 3-(3-butoxypropoxy)propoxy group, a 4-(4-butoxybutoxy)butoxy group, a 5-(5-butoxyhexyloxy)hexyloxy group, a (1-((1-butoxypropan-2-yl)oxy)propan-2-yl)oxy group, a 2-(2-butoxypropoxy)propoxy group,
a 2-(2-(2-methoxyethoxy)ethoxy)ethoxy group, a 3-(3-(3-methoxypropoxy)propoxy)propoxy group, a 4-(4-(4-methoxybutoxy)butoxy)butoxy group, a 5-(5-(5-methoxyhexyloxy)hexyloxy)hexyloxy group, a (1-((1-((1-methoxypropan-2-yl)oxy)propan-2-yl)oxy)propan-2-yl)oxy group, a 2-(2-(2-methoxypropoxy)propoxy)propoxy group,
a 2-(2-(2-ethoxyethoxy)ethoxy)ethoxy group, a 3-(3-(3-ethoxypropoxy)propoxy)propoxy group, a 4-(4-(4-ethoxybutoxy)butoxy)butoxy group, a 5-(5-(5-ethoxyhexyloxy)hexyloxy)hexyloxy group, a (1-((1-((1-ethoxypropan-2-yl)oxy)propan-2-yl)oxy)propan-2-yl)oxy group, a 2-(2-(2-ethoxypropoxy)propoxy)propoxy group,
a 2-(2-(2-propoxyethoxy)ethoxy)ethoxy group, a 3-(3-(3-propoxypropoxy)propoxy)propoxy group, a 4-(4-(4-propoxybutoxy)butoxy)butoxy group, a 5-(5-(5-propoxyhexyloxy)hexyloxy)hexyloxy group, a (1-((1-((1-propoxypropan-2-yl)oxy)propan-2-yl)oxy)propan-2-yl)oxy group, a 2-(2-(2-propoxypropoxy)propoxy)propoxy group,
a 2-(2-(2-butoxyethoxy)ethoxy)ethoxy group, a 3-(3-(3-butoxypropoxy)propoxy)propoxy group, a 4-(4-(4-butoxybutoxy)butoxy)butoxy group, a 5-(5-(5-butoxyhexyloxy)hexyloxy)hexyloxy group, a (1-((1-((1-butoxypropan-2-yl)oxy)propan-2-yl)oxy)propan-2-yl)oxy group, and a 2-(2-(2-butoxypropoxy)propoxy)propoxy group.

In the general formula (1), c is preferably 2 to 4. Having c within this range allows the condensation stress to be relaxed during curing of the polymetalloxane. This makes it possible to obtain a homogeneous cured film or metal oxide fiber in which cracks are hardly generated.

In the general formula (1), R⁴ is preferably a C₂-C₆ alkyl group. The polymetalloxane having the structure of the part bracketed by ( )ₐ in which R⁴ is a C₂-C₆ alkyl group has a further improved compatibility with other components. Thus, the polymetalloxane is present more stably in the solvent, and the solution has excellent storage stability.

In the general formula (1), when the content of the structure of the part bracketed by ( )ₐ is represented by the ratio of the number of moles of the structure of the part bracketed by ( )ₐ to the number of moles of M atoms contained in the polymetalloxane, the content of the structure is preferably 1 mol % or more and 250 mol % or less, and more preferably 15 mol % or more and 200 mol % or less. Bringing the content of the structure of the part bracketed by ( )ₐ in the polymetalloxane within this range allows the polymetalloxane to have a further improved compatibility with other components. The polymetalloxane is thus present particularly stably in a solvent.

The content of the structure of the part bracketed by ( )ₐ in the polymetalloxane is determined by the following method. A polymetalloxane solution is decomposed with pressure using sulfuric acid and then nitric acid, and then the resulting material is incinerated with heat. The obtained ash is melted with a mixed melting agent of sodium carbonate and boric acid, and then the resulting material is dissolved with dilute nitric acid to obtain a constant volume. For this solution, the M atoms contained in the polymetalloxane is measured using ICP emission spectrometry, the content of the M atoms is determined, and the content is converted into a molar concentration of the M atoms. Next, the polymetalloxane solution is filled in an NMR tube, and ¹H-NMR and ¹³C-NMR measurements are performed using a nuclear magnetic resonance apparatus (NMR) to determine the molar concentration of the structure of the part bracketed by ( )ₐ from the peak area corresponding to the structure of the part bracketed by ( )ₐ. The content of the structure of the part bracketed by ( )ₐ in the polymetalloxane may be determined by dividing the molar concentration of the structure of the part bracketed by ( )ₐ by the molar concentration of M atoms.

In the general formula (1), m is preferably an integer of 3 or more and 5 or less.

The lower limit value of the weight-average molecular weight of the polymetalloxane of the present invention is preferably 10,000 or more, more preferably 20,000 or more, and still more preferably 100,000 or more. The upper limit value of the weight-average molecular weight is preferably 1,000,000 or less, more preferably 800,000 or less, and still more preferably 500,000 or less. Having the weight-average molecular weight of the polymetalloxane within this range allows the polymetalloxane to have good coating properties. In addition, having the weight-average molecular weight of equal to or more than the lower limit value enhances the physical properties of the cured film and the metal oxide fiber described later, and affords a cured film and a metal oxide fiber having excellent crack resistance in particular. Further, having the-weight average molecular weight of the polymetalloxane within this range allows the polymetalloxane solution to develop stringiness, achieving good processability into a thread product in the spinning step described later. In addition, having the molecular weight of equal to or more than the lower limit value improves the crack resistance of the thread product, achieving an effect of obtaining a homogeneous metal oxide fiber with no cracks even in a step of baking.

The weight-average molecular weight in the present invention means a value measured by gel permeation chromatography (GPC) in terms of polystyrene. The weight-average molecular weight of the polymetalloxane is determined by the following method. In this method, first, the polymetalloxane is dissolved at a concentration of 0.2 wt % in a developing solvent to obtain a sample solution. Subsequently, this sample solution is injected into a column filled with a porous gel and a developing solvent and measured by gel permeation chromatography. The column eluate is detected by a differential refractive index detector, and the elution time is analyzed to determine the weight-average molecular weight of the polymetalloxane. As the developing solvent, one capable of dissolving the polymetalloxane at a concentration of 0.2 wt % is selected. In particular, when the polymetalloxane is dissolved in a solution of 0.02 mol/dm³ of lithium chloride and N-methyl-2-pyrrolidone, this solution is used as a developing solvent.

(Method for Producing Polymetalloxane)

A method for producing a polymetalloxane represented by the general formula (1) is subjected to no particular limitation, and the following method may be used.

A method for producing a polymetalloxane according to an embodiment of the present invention includes a step of polycondensing a compound represented by the following general formula (2) or a hydrolysate of the compound (hereinafter referred to as “compound represented by general formula (2) or the like”).

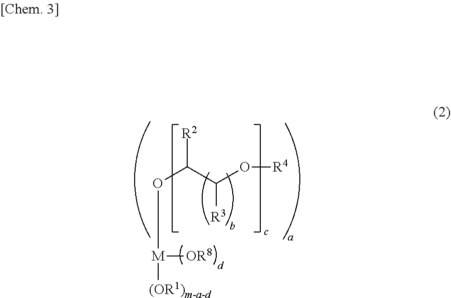

In the general formula (2), R⁸ is a hydrogen atom, a C₁-C₈ alkyl group, a C₁-C₈ alkylcarbonyl group, a C₆-C₁₂ aryl group, or a C₇-C₁₃ aralkyl group. d is an integer of 2 to (m−a). Those represented by the same symbols as in the general formula (1) are the same as those in the general formula (1).

The compound represented by the general formula (2) may be obtained by causing a metal alkoxide represented by the following general formula (3) and a compound represented by the following general formula (4) to react with each other at a predetermined molar ratio to obtain a compound in which a in the general formula (2) is 1, 2 or 3.

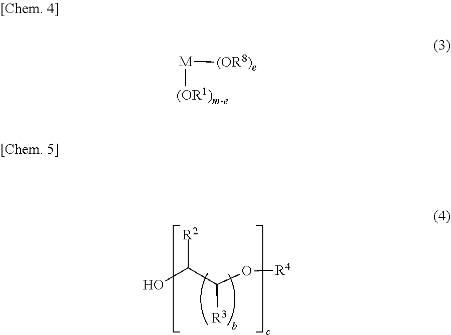

In the general formula (3), e is an integer of 3 to m.

Those represented by the same symbols as in the general formula (2) are the same as those in the general formula (2).

The metal alkoxide represented by the general formula (3) is subjected to no particular limitation, and specific examples thereof include the following metal alkoxides when m−e=0.

When the metal atom M is Ti, examples of the metal alkoxide include tetramethoxytitanium, tetraethoxytitanium, tetrapropoxytitanium, tetraisopropoxytitanium, tetrabutoxytitanium, tetra-s-butoxytitanium, tetraisobutoxytitanium, and tetra-t-butoxytitanium.

When the metal atom M is Zr, examples of the metal alkoxide include tetramethoxyzirconium, tetraethoxyzirconium, tetrapropoxyzirconium, tetraisopropoxyzirconium, tetrabutoxyzirconium, tetra-s-butoxyzirconium, tetraisobutoxyzirconium, and tetra-t-butoxyzirconium.

When the metal atom is Al, examples of the metal alkoxide include trimethoxyaluminum, triethoxyaluminum, tri-n-propoxyaluminum, triisopropoxyaluminum, tri-n-butoxyaluminum, tri-s-butoxyaluminum, s-butoxy(diisopropoxy)aluminum, triisobutoxyaluminum, and tri-t-butoxyaluminum.

When m−e≥1, specific examples the metal alkoxide include the following metal alkoxides.

Of the alkoxy groups listed in the examples of the metal alkoxide when m−e=0, the groups in which (m−e) alkoxy groups are replaced with any group selected from the following group:
a trihydroxysiloxy group, a trimethylsiloxy group, a triethylsiloxy group, a tripropylsiloxy group, a triisopropylsiloxy group, a tributylsiloxy group, a triisobutylsiloxy group, a tri-s-butylsiloxy group, a tri-t-butylsiloxy group, a tricyclohexylsiloxy group, a trimethoxysiloxy group, a triethoxysiloxy group, a tripropoxysiloxy group, a triisopropoxysiloxy group, a tributoxysiloxy group, a triphenylsiloxy group, a hydroxydiphenylsiloxy group, a methyldiphenylsiloxy group, an ethyldiphenylsiloxy group, a propyldiphenylsiloxy group, a dihydroxy(phenyl)siloxy group, a dimethyl(phenyl)siloxy group, a diethyl(phenyl)siloxy group, a dipropyl(phenyl)siloxy group, a trinaphthylsiloxy group, a hydroxydinaphthylsiloxy group, a methyldinaphthylsiloxy group, an ethyldinaphthylsiloxy group, a propyldinaphthylsiloxy group, a dihydroxy(naphthyl)siloxy group, a dimethyl(naphthyl)siloxy group, a diethyl(naphthyl)siloxy group, a dipropyl(naphthyl)siloxy group;
an N-succinimidyloxy group, an N-phthalimidyloxy group, an N-(5-norbornene-2,3-dicarboxyimidyl)oxy group, an N—(N′-hydroxypyromellitimidyl)oxy group, an N-(1,8-naphthalimidyl)oxy group, an N—(N′-hydroxy-1,2,3,4-cyclobutanetetracarboxylic acid diimidyl)oxy group;
a (4-oxopent-2-en-2-yl)oxy group;
a (4-methoxy-4-oxobuta-2-en-2-yl)oxy group, a (4-ethoxy-4-oxobuta-2-en-2-yl)oxy group, a (4-propoxy-4-oxobuta-2-en-2-yl)oxy group, a (4-butoxy-4-oxobuta-2-en-2-yl)oxy group;
a (4-phenyloxy-4-oxobuta-2-en-2-yl)oxy group, and a (4-naphthyloxy-4-oxobuta-2-en-2-yl)oxy group.

Specific examples of the compound having a structure represented by the general formula (4) include
2-methoxyethanol, 3-methoxypropanol, 4-methoxybutanol, 5-methoxyhexanol, 1-methoxypropan-2-ol, 2-methoxypropanol,
2-ethoxyethanol, 3-ethoxypropanol, 4-ethoxybutanol, 5-ethoxyhexanol, 1-ethoxypropan-2-ol, 2-ethoxypropanol,
2-propoxyethanol, 3-propoxypropanol, 4-propoxybutanol, 5-propoxyhexanol, 1-propoxypropan-2-ol, 2-propoxypropanol,
2-butoxyethanol, 3-butoxypropanol, 4-butoxybutanol, 5-butoxyhexanol, 1-butoxypropan-2-ol, 2-butoxypropanol,
2-(2-methoxyethoxy)ethanol, 3-(3-methoxypropoxy)propanol, 4-(4-methoxybutoxy)butanol, 5-(5-methoxyhexyloxy)hexanol, 1-((1-methoxypropan-2-yl)oxy)propan-2-ol, 2-(2-methoxypropoxy)propanol,
2-(2-ethoxyethoxy)ethanol, 3-(3-ethoxypropoxy)propanol, 4-(4-ethoxybutoxy)butanol, 5-(5-ethoxyhexyloxy)hexanol, 1-((1-ethoxypropan-2-yl)oxy)propan-2-ol, 2-(2-ethoxypropoxy)propanol,
2-(2-propoxyethoxy)ethanol, 3-(3-propoxypropoxy)propanol, 4-(4-propoxybutoxy)butanol, 5-(5-propoxyhexyloxy)hexanol, 1-((1-propoxypropan-2-yl)oxy)propan-2-ol, 2-(2-propoxypropoxy)propanol,
2-(2-butoxyethoxy)ethanol, 3-(3-butoxypropoxy)propanol, 4-(4-butoxybutoxy)butanol, 5-(5-butoxyhexyloxy)hexanol, 1-((1-butoxypropan-2-yl)oxy)propan-2-ol, 2-(2-butoxypropoxy)propanol,
2-(2-(2-methoxyethoxy)ethoxy)ethanol, 3-(3-(3-methoxypropoxy)propoxy)propanol, 4-(4-(4-methoxybutoxy)butoxy)butanol, 5-(5 (5-methoxyhexyloxy)hexyloxy)hexanol, 1-((1-((1-methoxypropan-2-yl)oxy)propan-2-yl)oxy)propan-2-ol, 2-(2-(2-methoxypropoxy)propoxy)propanol,
2-(2-(2-ethoxyethoxy)ethoxy)ethanol, 3-(3-(3-ethoxypropoxy)propoxy)propanol, 4-(4-(4-ethoxybutoxy)butoxy)butanol, 5-(5-(5-ethoxyhexyloxy)hexyloxy)hexanol, 1-((1-((1-ethoxypropan-2-yl)oxy)propan-2-yl)oxy)propan-2-ol, 2-(2-(2-ethoxypropoxy)propoxy)propanol,
2-(2-(2-propoxyethoxy)ethoxy)ethanol, 3-(3-(3-propoxypropoxy)propoxy)propanol, 4-(4-(4-propoxybutoxy)butoxy)butanol, 5-(5-(5-propoxyhexyloxy)hexyloxy)hexanol, 1-((1-((1-propoxypropan-2-yl)oxy)propan-2-yl)oxy)propan-2-ol, 2-(2-(2-propoxypropoxy)propoxy)propanol,
2-(2-(2-butoxyethoxy)ethoxy)ethanol, 3-(3-(3-butoxypropoxy)propoxy)propanol, 4-(4-(4-butoxybutoxy)butoxy)butanol, 5-(5-(5-butoxyhexyloxy)hexyloxy)hexanol, 1-((1-((1-butoxypropan-2-yl)oxy)propan-2-yl)oxy)propan-2-ol, and 2-(2-(2-butoxypropoxy)propoxy)propanol.

In the reaction between the metal alkoxide represented by the general formula (3) and the compound represented by the general formula (4), a solvent may be added to the reaction mixture as necessary. As the solvent, those described later may be used. The reaction temperature is preferably 20 to 100° C., and the reaction time is preferably 10 to 120 minutes.

For the purpose of hydrolyzing the remaining alkoxide after the compound represented by the general formula (2) is obtained by the above reaction, a necessary amount of water is added, the resulting mixture is stirred, a hydrolysis reaction is performed. As necessary, alcohol generated is removed from the system. The reaction time is preferably 10 to 120 minutes.

When the hydrolysis reaction is completed, the compound represented by the general formula (2) changes to a compound having a hydroxy group represented by the following general formula (5).

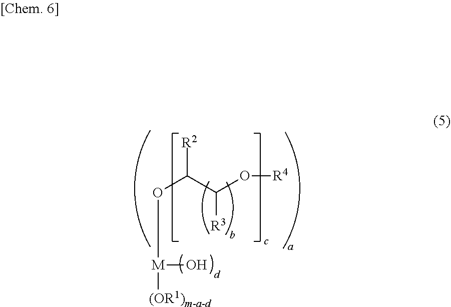

In the general formula (5), those represented by the same symbols as in the general formula (2) are the same as those in the general formula (2).

A metal compound having a hydroxy group typically aggregates because of a hydrogen bond of the hydroxy group, and it becomes insoluble in an organic solvent. However, the compound represented by the general formula (5) does not aggregate in an organic solvent by having the structure of the part bracketed by ( )ₐ in a side chain. Thus, a solution containing the compound represented by the general formula (5) can be present as a transparent and uniform solution.

After completion of the hydrolysis, for the purpose of producing the polymetalloxane represented by the general formula (1), the temperature of the reaction mixture is raised in the range of 60° C. to 180° C., a polymerization catalyst is added as necessary, condensed water and alcohol generated are removed, and the polycondensation is advanced to obtain a polymetalloxane solution.

The solvent is subjected to no particular limitation, and an amide-based solvent, an ester-based solvent, an alcohol-based solvent, an ether-based solvent, a ketone-based solvent, dimethyl sulfoxide, or the like may be suitably used.

Specific examples of the amide-based solvent include N,N-dimethylformamide, N,N-dimethylacetamide, N,N-dimethylisobutyramide, N-methyl-2-pyrrolidone, 1,3-dimethyl-2-imidazolidinone, and N,N-dimethylpropyleneurea.

Specific examples of the ester-based solvent include γ-butyrolactone, ethyl acetate, isobutyl acetate, propylene glycol monomethyl ether acetate, and ethyl acetoacetate.

Specific examples of the alcohol-based solvent include n-propanol, isopropanol, n-butanol, isobutanol, t-butanol, ethyl lactate, butyl lactate, propylene glycol monomethyl ether, diethylene glycol monomethyl ether, ethylene glycol, and propylene glycol.

Specific examples of the ether-based solvent include 1,2-dimethoxyethane, 1,2-diethoxyethane, and dipropylene glycol dimethyl ether.

Specific examples of the ketone-based solvent include diisobutyl ketone, acetylacetone, cyclopentanone, and cyclohexanone.

Examples of other solvents that can be preferably used include solvents described in International Publication No. 2017/90512 or International Publication No. 2019/188835.

The polymerization catalyst to be added as necessary is not subjected to particular limitation, and an acidic catalyst or a basic catalyst is preferably used. Specific examples of the acidic catalyst include hydrochloric acid, nitric acid, sulfuric acid, hydrofluoric acid, phosphoric acid, acetic acid, trifluoroacetic acid, formic acid, a polyvalent carboxylic acid or an anhydride thereof, and an ion exchange resin. Specific examples of the basic catalyst include triethylamine, tripropylamine, tributylamine, tripentylamine, trihexylamine, triheptylamine, trioctylamine, diethylamine, dipropylamine, dibutylamine, diisobutylamine, dipentylamine, dihexylamine, diheptylamine, dioctylamine, triethanolamine, diethanolamine, dicyclohexylamine, dicyclohexylmethylamine, sodium hydroxide, potassium hydroxide, an alkoxysilane having an amino group, and an ion exchange resin.

A more preferable polymerization catalyst is a basic catalyst. Using a basic catalyst makes it possible to obtain a high-molecular-weight polymetalloxane in particular. Of the basic catalysts, diethylamine, dipropylamine, dibutylamine, dipentylamine, dihexylamine, diheptylamine, dioctylamine, triethylamine, tripropylamine, tributylamine, triisobutylamine, tripentylamine, trihexylamine, triheptylamine, trioctylamine, diethanolamine, triethanolamine, dicyclohexylamine, dicyclohexylmethylamine, and 2,2,6,6-tetramethylpiperidine are particularly preferable.

The amount of the polymerization catalyst to be added is preferably 0.01 to 30 mol % with respect to 100 mol % of the compound represented by the general formula (2).

From the viewpoint of the storage stability of the composition, the polymetalloxane solution after the hydrolysis, the partial condensation, and the polymerization preferably does not contain the above-mentioned polymerization catalyst. Accordingly, the polymerization catalyst may be removed as necessary. A method for the removal is subjected to no particular limitation, and washing with water and/or a treatment with an ion exchange resin is/are preferable from the viewpoint of simple operation and removing performance. Washing with water is a method in which a polymetalloxane solution is diluted with a suitable hydrophobic solvent, the resulting solution is then washed with water several times, and the obtained organic layer is concentrated with an evaporator or the like. A treatment with an ion exchange resin is a method in which a polymetalloxane solution is brought into contact with a suitable ion exchange resin.

(Composition Containing Polymetalloxane)

The polymetalloxane according to an embodiment of the present invention may be mixed with a solvent or another necessary component to be made into a composition. That is, the composition according to an embodiment of the present invention includes at least the above-described polymetalloxane.

In the present invention, when the polymetalloxane is made into a composition, the polymetalloxane is preferably diluted with an organic solvent to adjust the solid content concentration. The solid content concentration of the solution containing the polymetalloxane is preferably 0.1 to 50 wt %. Bringing the solid content concentration within this range allows the composition to be adjusted to have any viscosity. This makes it possible to achieve both stringiness and fluidity of this composition. The solid content refers to a component other than a solvent in the composition.

The organic solvent is subjected to no particular limitation, and it is preferably the same as the solvent used in the synthesis of the polymetalloxane. A further preferable organic solvent is an aprotic polar solvent. Using an aprotic polar solvent as the organic solvent causes an interaction between the polymetalloxane and the organic solvent, enabling the composition containing them to have a high viscosity. Thus, a thread product can be easily obtained from the composition in the spinning step described later.

Specific examples of the aprotic polar solvent include acetone, tetrahydrofuran, ethyl acetate, dimethoxyethane, N,N-dimethylformamide, dimethylacetamide (DMAc, 165° C.), dipropylene glycol dimethyl ether, tetramethylurea, diethylene glycol ethyl methyl ether, dimethyl sulfoxide, N-methylpyrrolidone, γ-butyrolactone, 1,3-dimethyl-2-imidazolidinone, propylene carbonate, and N,N′-dimethylpropyleneurea.

At the time of adjusting the solid content concentration of the polymetalloxane solution, other components may be added to this solution. Examples of other components include a surfactant such as a fluorine-based surfactant and a silicone-based surfactant, a silane coupling agent, a crosslinking agent, and a crosslinking accelerator. Specific examples thereof include those described in International Publication No. 2017/90512 or International Publication No. 2019/188835.

(Solid Material)

Heating and curing the polymetalloxane according to an embodiment of the present invention or a composition of the polymetalloxane makes it possible to obtain a solid material containing one or more metal atoms selected from the group consisting of Al, Sc, Ti, V, Cr, Mn, Fe, Co, Ni, Cu, Zn, Ga, Ge, Y, Zr, Nb, Mo, Pd, Ag, In, Sn, Sb, Hf, Ta, W, and Bi, and an oxygen atom. Since the solid material thus obtained is a cured product mainly composed of a resin having a metal atom having a high electron density in the main chain, the concentration of metal atoms in the solid material can be increased, and a solid material having a high density can be easily obtained. In addition, the solid material obtained becomes a dielectric having no free electrons, and thus it has high heat resistance.

Examples of the form of the solid material include a film and a fiber. Specific embodiments and production methods will be described later. When the solid material is a film, it may be referred to as a cured film.

The carbon atom amount in the solid material is preferably 10 atomic % or less, more preferably 8 atomic % or less, still more preferably 5 atomic %. Having the carbon atom amount in the solid material within the above-described range allows the solid material to have a high heat resistance.

The carbon atom amount in the solid material may be measured by Rutherford backscattering spectrometry (RBS). Specifically, the solid material is irradiated with an ion beam (H⁺ or He⁺⁺), and the energy and intensity of ions scattered backward by Rutherford scattering are measured. From the scattered ion energy spectrum obtained, the mass number of the collided atoms is examined, and the average atomic number ratios of the solid material are obtained. From the obtained average atomic number ratios, the average atomic number ratio of carbon atoms is selected, which is taken as the carbon atom amount in the solid material.

(Fiber Application)

A solution of the polymetalloxane according to an embodiment of the present invention or a composition of the polymetalloxane may be formed into a fiber by spinning. That is, the fiber according to an embodiment of the present invention contains the polymetalloxane described above or contains a composition of the polymetalloxane described above. The fiber thus obtained may be formed into a metal oxide fiber by baking.

A fiber composed of a metal oxide has properties such as high heat resistance, high strength, and surface activity, and it is expected to have properties useful for various applications. Such a fiber (metal oxide fiber) is commonly produced by a melt-fiberizing method. This method is as follows. For example, in this method, a metal oxide raw material and a compound having a low melting point, such as silica, are first mixed. Next, this mixture is melted in a high-temperature furnace, and then, the melt is taken out as a thin stream. The thin stream is rapidly cooled with application of high-pressure air or application of a centrifugal force to form a metal oxide fiber. In the melt-fiberizing method, however, when the concentration of the metal oxide raw material increases, the melting temperature increases, and thus it is difficult to obtain a metal oxide fiber containing a high concentration of metal oxide (hereinafter abbreviated as a fiber with a high concentration of metal oxide, as appropriate).

In a typically known method for obtaining a fiber with a high concentration of metal oxide, a spinning solution containing a metal oxide raw material and a thickener is used to produce a fibrous precursor, and the fibrous precursor is spun with heat. However, such a method has a problem that pores and cracks are generated when the thickener burns out in a baking process, and as a result, the strength of the resulting metal oxide fiber is insufficient.

The polymetalloxane according to an embodiment of the present invention and a composition of the polymetalloxane can be treated in the form of a solution, and thus, can be spun without requiring such a melting step as performed in the melt fiberizing method described above. In addition, the polymetalloxane and a composition of the polymetalloxane, when spun, do not require a thickener, and thus, make it possible to obtain a dense metal oxide fiber. Thus, it is made possible to easily obtain a metal oxide fiber having properties such as high heat resistance, high strength, and surface activity.

(Method for Producing Fiber)

A method for producing a fiber according to an embodiment of the present invention includes at least a spinning step of spinning the above-mentioned polymetalloxane or a composition thereof to obtain a fiber. In this spinning step, a known method may be used as the method for spinning the polymetalloxane or a composition thereof. Examples of the spinning method include a dry spinning method, a wet spinning method, a dry-wet spinning method, and an electrospinning method. Hereinafter, the “polymetalloxane or a composition thereof” is abbreviated as a “composition or the like” as appropriate.

The dry spinning method is a method in which the composition or the like is extruded under a load into an atmosphere through spinnerets having pores, and the organic solvent is evaporated to form a thread product. In this method, the composition or the like may be heated to reduce its viscosity when extruded. The composition or the like may be extruded into a heated atmosphere so that the evaporation rate of the organic solvent is controlled. After the composition or the like is extruded, the thread product may be stretched with a roller that rotates the thread product or a high-speed air flow.

The wet spinning is a method in which the composition or the like is extruded under a load into a coagulation bath through spinnerets having pores, and the organic solvent is removed to obtain a thread product. For the coagulation bath, water or a polar solvent is preferably used. The dry-wet spinning is a method in which the composition or the like is extruded into an atmosphere, and then immersed in a coagulation bath, and the organic solvent is removed to obtain a thread product.

The electrospinning method is a method in which a high voltage is applied to a nozzle filled with the composition or the like, and electric charges are thereby gathered in liquid droplets at the tip of the nozzle and repel each other to spread the droplets, whereby the solution stream is stretched to be spun. This method makes it possible to obtain a thread product having a small diameter. Thus, using to the electrospinning method makes it possible to obtain a thin thread product having a diameter of tens nanometers to several micrometers.

Of these, in particular, a dry spinning method or an electrospinning method may be preferably used as the spinning method in the spinning step in the present invention.

In the spinning step in embodiments of the present invention, the fiber obtained by spinning may undergo, as necessary, a drying treatment, a steam treatment, a hot-water treatment, or a combination of these treatments before undergoing baking.

Baking the fiber obtained by spinning in the above-described spinning step, makes it possible that the crosslinking reaction progresses, and organic components such as organic groups are removed, and whereby a metal oxide fiber having excellent strength can be obtained. That is, the method for producing a fiber according to an embodiment of the present invention includes the above-described spinning step and the baking step of baking the fiber obtained in the spinning step when the fiber to be produced is a metal compound fiber. In this baking step, the baking temperature is subjected to no particular limitation, and it is preferably 200° C. or more and 2000° C. or less, and more preferably 400° C. or more and 1500° C. or less. The baking method is subjected to no particular limitation. Examples of the baking method include a method of baking in an air atmosphere, a method of baking in an inert atmosphere such as nitrogen or argon, and a method of baking in vacuum.

In the baking step in embodiments of the present invention, the obtained metal oxide fiber may be further baked in a reducing atmosphere such as hydrogen. In this baking step, the fiber or the metal oxide fiber obtained by spinning may be baked with tension applied thereto.

Such a method makes it possible to obtain a continuous and dense metal oxide fiber having an average fiber diameter of 0.01 μm or more and 1000 μm or less. The metal oxide fiber preferably has an average fiber diameter of 0.01 μm or more and 1000 μm or less, and more preferably 0.10 μm or more and 200 μm or less. Having the average fiber diameter within the above range enables the metal oxide fiber to be a homogeneous fiber with no cracks.

The average fiber diameter of the resulting metal oxide fiber is determined by the following method. For example, an adhesive tape is bonded to a piece of backing paper. To the resulting piece, a single fiber whose fiber diameter is to be measured is bonded horizontally to obtain a single fiber test piece. The upper face of the single fiber test piece is observed with an electron microscope, and the width of the image is regarded as the fiber diameter. Three measurements are taken along the length direction, and the average of the measurement values is regarded as the fiber diameter. This operation is performed on 20 single fibers selected randomly. The fiber diameters obtained are averaged to afford an average fiber diameter.

The fiber, such as the metal oxide fiber, obtained by spinning a solution of the polymetalloxane according to an embodiment of the present invention or a composition thereof and baking the fiber obtained by this spinning may be utilized as a photocatalyst, a heat-insulating material, a heat-radiating material, or a composite material, such as a fiber-reinforced plastic (FRP). For example, as a photocatalyst, such a fiber may be used for a filter for purification of water or the air. As a heat-insulating material or a heat-radiating material, such a fiber may be used for an electric furnace, a nuclear fuel rod sheath, an engine turbine of an aircraft, a heat exchanger, or the like.

(Cured Film and Method for Producing Cured Film)

The cured film according to an embodiment of the present invention contains the polymetalloxane described above or contains a composition of the polymetalloxane described above. In a method for producing a cured film according to an embodiment of the present invention, the polymetalloxane or a composition containing the polymetalloxane may be formed into a cured film by coating a base plate with the polymetalloxane or the composition containing the polymetalloxane and heating the coating. That is, this method for producing a cured film includes at least a heating step of heating the polymetalloxane described above or a composition thereof. The cured film thus obtained is a cured film mainly composed of a resin including a metal atom having a high electron density in the main chain, and thus the density of the metal atom in the cured film can be increased, and a high refractive index can be easily obtained. In addition, the cured film becomes a dielectric containing no free electron, and thus making it possible to obtain high heat resistance.

The base plate to be coated with the polymetalloxane or a composition thereof is subjected to no particular limitation, and examples thereof include a silicon wafer, a sapphire wafer, glass, and an optical film. Examples of the glass include alkali glass, alkali-free glass, thermally tempered glass, and chemically tempered glass. Examples of the optical film include a film made of an acrylic resin, a polyester resin, polycarbonate, polyarylate, polyethersulfone, polypropylene, polyethylene, polyimide, or a cycloolefin polymer.

Specifically, the method for producing a cured film according to an embodiment of the present invention includes a coating step of coating a base plate with the above-described polymetalloxane or a composition thereof, and the above-described heating step. In this coating step, a known method may be used as a coating method in which a base plate is coated with the polymetalloxane or a composition thereof. Examples of an apparatus used for coating include: full-surface coating apparatuses such as for spin coating, dip coating, curtain flow coating, spray coating, or slit coating; or printing apparatuses such as for screen printing, roll coating, micro gravure coating, or inkjet.

In this coating step, after the base plate is coated with the polymetalloxane or a composition thereof, the coating may be heated (prebaked) using a heating device such as a hot plate or an oven as necessary. Prebaking is preferably performed at a temperature in the range of 50° C. to 150° C. for 30 seconds to 30 minutes to make a prebaked film of the coating film on the base plate. Prebaking enables the coating film to have good film thickness uniformity. The coating film after prebaking preferably has a film thickness of 0.1 μm or more and 15 μm or less.

After the coating step is performed, a heating step of heating the polymetalloxane or a composition thereof on the base plate to obtain a cured film is performed. In this heating step, the coating film or the prebaked film obtained in the coating step is heated (cured) at a temperature in the range of 150° C. to 450° C. for about 30 seconds to 2 hours using a heating device such as a hot plate or an oven. This makes it possible to obtain a cured film containing the polymetalloxane or a composition thereof. The cured film preferably has a film thickness of 0.1 μm or more and 15 μm or less.

The cured film obtained as described above preferably has a refractive index of 1.53 or more and 2.20 or less at a wavelength of 550 nm, and the reflective index is more preferably 1.65 or more and 2.10 or less.

The refractive index of the cured film may be measured by the following method. For example, in this method for measuring the refractive index, a spectral ellipsometer is used to measure a change in the state of polarization of reflected light from each of the cured film and the base plate, and a phase difference from the incident light and a spectrum of amplitude reflectance are obtained. A refractive index spectrum is obtained by fitting a dielectric function of a computation model closer to the spectrum obtained. Reading the refractive index value at a wavelength of 550 nm from the refractive index spectrum obtained makes it possible to obtain the refractive index of the cured film.

(Application of Cured Film)

The cured film according to an embodiment of the present invention has excellent refractive index and insulating properties, and thus, it is suitably used for a member of an electronic component such as a solid-state imaging device or a display. The member refers to one of the parts used to assemble an electronic component. That is, the member according to an embodiment of the present invention includes a cured film containing the above-described polymetalloxane or a composition thereof. An electronic component according to an embodiment of the present invention includes such a cured film. Examples of the member of a solid-state imaging device include a condensing lens, an optical waveguide connecting a condensing lens and a photosensor unit, and an antireflection film. Examples of the member of a display include an index matching material, a planarizing material, and an insulating protecting material.

The cured film according to an embodiment of the present invention may also be used as a protective film in a multilayer NAND flash memory, a dry etching resist, a buffer coat in a semiconductor device, an interlayer insulating film, and one of various protective films.

In addition, the cured film according to an embodiment of the present invention has a high etching resistance because it is mainly composed of a polymetalloxane including, in the main chain, a metal atom having a low reactivity with an etching gas or an etching liquid used when an inorganic solid material is patterned by etching. Therefore, a pattern formed of the cured film of the present invention may be used as a mask used in patterning an inorganic solid material by etching.

The cured film obtained from the composition according to embodiments of the present invention has a low film stress as compared with a carbon film. Thus, when a cured film containing the polymetalloxane is formed on an inorganic solid material, stress applied to the base plate and the inorganic solid material can be reduced.

Examples of such a utilization method include a method for producing an inorganic solid material pattern including the steps of: coating an inorganic solid material with a composition according to embodiments of the present invention; heating a coating film obtained in the coating at a temperature of 100° C. or more and 1000° C. or less to form a cured film; forming a pattern of the cured film; and patterning the inorganic solid material by etching using the pattern of the cured film as a mask.

In this method, the details of the steps up to the formation of the cured film are as described above. The inorganic solid material preferably contains SiO₂ or Si₃N₄. The inorganic solid material is preferably composed of one or more materials selected from the group consisting of SiO₂, Si₃N₄, Al₂O₃, TiO₂, and ZrO₂. The inorganic solid material is preferably a stack body of a plurality of inorganic solid material layers.

A method for forming a pattern of the cured film is subjected to no particular limitation, and for example, a method is preferable in which a photoresist pattern is formed on the cured film, or a hard mask pattern formed of a compound selected from the group consisting of SiO₂, Si₃N₄, and carbon, or a composite compound of these compounds is formed, and the cured film is etched.

As a method for etching the cured film, a dry etching method or a wet etching method may be used using a photoresist pattern or a hard mask pattern as a mask.

In the dry etching method for the cured film, with a reactive ion etching apparatus (RiE apparatus), a process gas is preferably methane trifluoride (CHF₃), methane tetrafluoride (CF₄), Cl₂ (chlorine), BCl₃ (boron trichloride), CCl₃ (carbon tetrachloride), oxygen, or a mixed gas thereof. Wet etching of a heat treatment film is preferably performed by using hydrofluoric acid (HF), nitric acid (HNO₃), ammonium fluoride (NH₄F), phosphoric acid (H₃PO₄), or a mixture thereof diluted with water and/or acetic acid (CH₃COOH).

The etching of the inorganic solid material using the pattern of the cured film as a mask is preferably dry etching or wet etching.

In dry etching of the inorganic solid material, with a reactive ion etching apparatus (RiE apparatus), a process gas is preferably SF₆ (sulfur hexafluoride), NF₃ (nitrogen trifluoride), CF₄ (carbon tetrafluoride), C₂F₆ (ethane hexafluoride), C₃F₈ (propane octafluoride), C₄F₆ (hexafluoro-1,3-butadiene), CHF₃ (trifluoromethane), CH₂F₂ (difluoromethane), COF₂ (carbonyl fluoride), oxygen, or a mixed gas thereof.

Wet etching of the inorganic solid material is preferably performed by using hydrofluoric acid (HF), nitric acid (HNO₃), ammonium fluoride (NH₄F), phosphoric acid (H₃PO₄), or a mixture thereof diluted with water and/or acetic acid (CH₃COOH).

### EXAMPLES

The present invention will now be described in more detail with reference to Examples, but these Examples are not intended to limit the present invention.

(Materials Used in Examples and Comparative Examples)

DMIB: N,N′-dimethylisobutyramide (manufactured by Mitsubishi Gas Chemical Company, Inc.).

TPnB: 1-((1-((1-butoxypropan-2-yl)oxy)propan-2-yl)oxy)propan-2-ol (manufactured by Sigma-Aldrich Co. LLC.)

PnB: 1-butoxypropan-2-ol (manufactured by Sigma-Aldrich Co. LLC.)

DPnB: 1-((1-butoxypropan-2-yl)oxy)propan-2-ol (manufactured by Sigma-Aldrich Co. LLC.)

DPM: 1-((1-methoxypropan-2-yl)oxy)propan-2-ol (manufactured by Sigma-Aldrich Co. LLC.).

(Solid Content Concentration)

In each of Synthesis Examples and Examples, the solid content concentration of a polymetalloxane solution was determined by weighing 1.0 g of the polymetalloxane solution in an aluminum cup, heating the solution at 250° C. for 30 minutes using a hot plate to evaporate the liquid content, and weighing the solid content remaining in the aluminum cup after heating.

(Infrared Spectroscopic Analysis)

Analysis by Fourier transform infrared spectroscopy (hereinafter abbreviated as FT-IR) was performed by the following method. First, two silicon wafers superposed one upon the other were measured with a Fourier transform infrared spectrometer (FT 720 manufactured by Shimadzu Corporation), and the measurement result was used as a baseline. Next, one drop of a metal compound or a solution thereof was dropped on a silicon wafer, then sandwiched between the silicon wafer and another silicon wafer, whereby a measurement sample was obtained. An absorbance of the compound or a solution of the compound was calculated from the difference between the absorbance of the measurement sample and absorption of the baseline, and the absorption peak was read.

(Measurement of Weight-Average Molecular Weight)

The weight-average molecular weight (Mw) was determined by the following method. Lithium chloride was dissolved in N-methyl-2-pyrrolidone to prepare a 0.02 mol/dm³ lithium chloride/N-methyl-2-pyrrolidone solution as a developing solvent. A polymetalloxane was dissolved at 0.2 wt % in the developing solvent, and the solution thus obtained was used as a sample solution. The developing solvent was allowed to flow into a porous gel column (TSK gel α-M and α-3000, one each, manufactured by Tosoh Corporation) at a flow rate of 0.5 mL/min. Into the column, 0.2 mL of the sample solution was injected and analyzed by gel permeation chromatography. The eluate from the column was detected by a differential refractive index detector (Model RI-201, manufactured by Showa Denko K.K.), and the elution time was analyzed to determine the weight-average molecular weight (Mw) in terms of polystyrene.

(Measurement of Content of Structure of Part Bracketed by ( )ₐ in Polymetalloxane)

The content of the structure of the part bracketed by ( )ₐ in the polymetalloxane was represented by the ratio of the number of moles of the structure of the part bracketed by ( )ₐ to the number of moles of M atoms contained in the polymetalloxane. Specifically, the polymetalloxane solution was decomposed with pressure using sulfuric acid and then nitric acid, and then the resulting material was incinerated with heat. The obtained ash was melted with a mixed melting agent of sodium carbonate and boric acid, and then the resulting material was dissolved with dilute nitric acid to obtain a constant volume. For this solution, the M atoms contained in the polymetalloxane was measured using ICP emission spectrometry, the content of the M atoms was determined, and the content was converted into a molar concentration of the M atoms. Next, the polymetalloxane solution was filled in an NMR tube, and ¹H-NMR and ¹³C-NMR measurements were performed using a nuclear magnetic resonance apparatus (NMR) to determine the molar concentration of the structure of the part bracketed by ( )ₐ from the peak area corresponding to the structure of the part bracketed by ( )ₐ. The value obtained by dividing the molar concentration of the structure of the part bracketed by ( )ₐ by the molar concentration of M atoms was regarded as the content of the structure of the part bracketed by ( )ₐ in the polymetalloxane.

(Measurement of Viscosity)

The viscosity was measured by the following method. The temperature of the sample was set to 25° C., and the viscosity of the sample was measured at a rotation speed of 3 rpm using a B-type viscometer with a digital calculation function (DV-II, manufactured by Brookfield, USA).

(Evaluation of Storage Stability)

The storage stability was measured by the following method. The viscosity of the polymetalloxane solution obtained in each of Examples and Comparative Examples was measured immediately after the completion of the synthesis, which was taken as a viscosity before storage. Next, the polymetalloxane solution obtained in each of Examples and Comparative Examples was placed in an airtight container, and the viscosity after storage at 23° C. for 7 days was measured, which was taken as a viscosity after storage. The storage stability was evaluated from the viscosity change rate=((viscosity after storage−viscosity before storage/viscosity before storage) according to the following criteria.
A: Viscosity change rate is less than 10%
B: Viscosity change rate is 10% or more and less than 50%
C: Viscosity change rate is 50% or more and less than 100%
D: Viscosity change rate is 100% or more.

### (Synthesis Example 1) Synthesis of Tripropoxy(trimethylsiloxy)zirconium

Tripropoxy(trimethylsiloxy)zirconium was synthesized by the method described in Synthesis Example 8 of Japanese Patent No. 6327366.

### (Synthesis Example 2) Synthesis of Di-s-butoxy(trimethylsiloxy)aluminum

Into a three-necked flask having a volume of 500 ml, 24.6 g (0.1 mol) of tri-s-butoxyaluminum was fed, and the flask was immersed in an oil bath at 40° C. The resulting material was stirred for 30 minutes. Thereafter, 9.0 g (0.1 mol) of trimethylsilanol was added over 1 hour using a dropping funnel, and after the addition, the mixture was further stirred for 1 hour. The contents of the flask were transferred to a 200 ml recovery flask, and the produced s-butanol was distilled off under reduced pressure to obtain a colorless liquid aluminum compound.

The aluminum compound was analyzed by FT-IR. An absorption peak of Al—O—Si (949 cm⁻¹) was observed, and no absorption peak of silanol (883 cm⁻¹) was observed. Thus, it was confirmed that the obtained aluminum compound was di-s-butoxy(trimethylsiloxy)aluminum.

### (Synthesis Example 3) Synthesis of Zirconium Compound (Z-1)

Into a three-necked flask having a volume of 500 ml, 35.8 g (0.1 mol) of tripropoxy(trimethylsiloxy)zirconium was fed, and the flask was immersed in an oil bath at 40° C. The resulting material was stirred for 30 minutes. Thereafter, 24.8 g (0.1 mol) of TPnB was added over 1 hour using a dropping funnel, and after the addition, the mixture was further stirred for 1 hour. The contents of the flask were transferred to a 200 ml recovery flask, and the produced propanol was distilled off under reduced pressure to obtain a colorless liquid zirconium compound (Z-1).

The zirconium compound (Z-1) was analyzed by FT-IR. The absorption derived from propoxy (1122 cm⁻¹) was reduced as compared with tripropoxy(trimethylsiloxy)zirconium, and a peak derived from a bond between TPnB and zirconium (1095 cm⁻¹) was newly confirmed. In addition, an absorption peak of Zr—O—Si (968 cm⁻¹) was also confirmed, and thus it was confirmed that the obtained zirconium compound (Z-1) was a zirconium compound having the following structure.

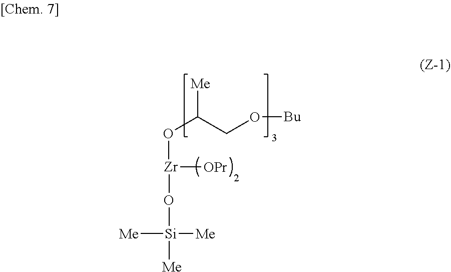

### (Synthesis Example 4) Synthesis of Zirconium Compound (Z-2)

Into a three-necked flask having a volume of 500 ml, 35.8 g (0.1 mol) of tripropoxy(trimethylsiloxy)zirconium was fed, and the flask was immersed in an oil bath at 40° C. The resulting material was stirred for 30 minutes. Thereafter, 13.2 g (0.1 mol) of PnB was added over 1 hour using a dropping funnel, and after the addition, the mixture was further stirred for 1 hour. The contents of the flask were transferred to a 200 ml recovery flask, and the produced propanol was distilled off under reduced pressure to obtain a colorless liquid zirconium compound (Z-2).

The zirconium compound (Z-2) was analyzed by FT-IR. The absorption derived from propoxy (1122 cm⁻¹) was reduced as compared with tripropoxy(trimethylsiloxy)zirconium, and a peak derived from a bond between PnB and zirconium (1095 cm⁻¹) was newly confirmed. In addition, an absorption peak of Zr—O—Si (968 cm⁻¹) was also confirmed, and thus it was confirmed that the obtained zirconium compound (Z-2) was a zirconium compound having the following structure.

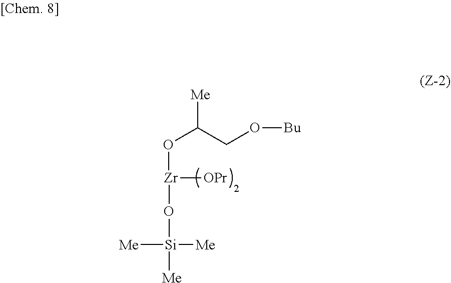

### (Synthesis Example 5) Synthesis of Zirconium Compound (Z-3)

Into a three-necked flask having a volume of 500 ml, 35.8 g (0.1 mol) of tripropoxy(trimethylsiloxy)zirconium was fed, and the flask was immersed in an oil bath at 40° C. The resulting material was stirred for 30 minutes. Thereafter, 19.0 g (0.1 mol) of DPnB was added over 1 hour using a dropping funnel, and after the addition, the mixture was further stirred for 1 hour. The contents of the flask were transferred to a 200 ml recovery flask, and the produced propanol was distilled off under reduced pressure to obtain a colorless liquid zirconium compound (Z-3).

The zirconium compound (Z-3) was analyzed by FT-IR. The absorption derived from propoxy (1122 cm⁻¹) was reduced as compared with tripropoxy(trimethylsiloxy)zirconium, and a peak derived from a bond between DPnB and zirconium (1095 cm⁻¹) was newly confirmed. In addition, an absorption peak of Zr—O—Si (968 cm⁻¹) was also confirmed, and thus it was confirmed that the obtained zirconium compound (Z-3) was a zirconium compound having the following structure.

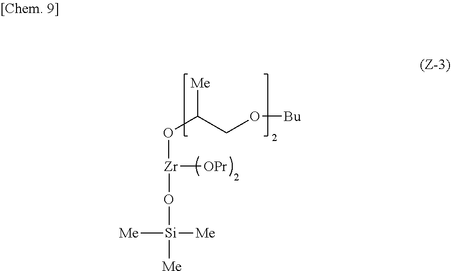

### (Synthesis Example 6) Synthesis of Zirconium Compound (Z-4)

Into a three-necked flask having a volume of 500 ml, 35.8 g (0.1 mol) of tripropoxy(trimethylsiloxy)zirconium was fed, and the flask was immersed in an oil bath at 40° C. The resulting material was stirred for 30 minutes. Thereafter, 14.8 g (0.1 mol) of DPM was added over 1 hour using a dropping funnel, and after the addition, the mixture was further stirred for 1 hour. The contents of the flask were transferred to a 200 ml recovery flask, and the produced propanol was distilled off under reduced pressure to obtain a colorless liquid zirconium compound (Z-4).

The zirconium compound (Z-4) was analyzed by FT-IR. The absorption derived from propoxy (1122 cm⁻¹) was reduced as compared with tripropoxy(trimethylsiloxy)zirconium, and a peak derived from a bond between DPM and zirconium (1095 cm⁻¹) was newly confirmed. In addition, an absorption peak of Zr-0-Si (968 cm⁻¹) was also confirmed, and thus it was confirmed that the obtained zirconium compound (Z-4) was a zirconium compound having the following structure.

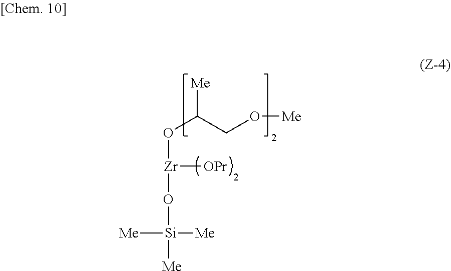

### (Example 1) Polymetalloxane (A-1) Solution

The zirconium compound (Z-1) synthesized in Synthesis Example 3 in an amount of 54.6 g (0.10 mol) and 5.0 g of DMIB as a solvent were mixed to obtain a solution 1. In addition, 3.60 g (0.20 mol) of water, 50.0 g of IPA as a water-diluting solvent, and 0.37 g (0.02 mol) of tributylamine as a polymerization catalyst were mixed to obtain a solution 2.

Into a three-necked flask having a volume of 500 mL, the entire amount of the solution 1 was fed, and the flask was immersed in an oil bath at 40° C. The solution was stirred for 30 minutes. Thereafter, the entire amount of the solution 2 was fed into a dropping funnel and then dropped into a flask over 1 hour for the purpose of hydrolysis. During the addition of solution 2, no precipitation occurred in the contents of the flask, and the solution was uniformly pale yellow and transparent. After the addition of the solution 2, the mixture was further stirred for 1 hour to obtain a hydroxy-group-containing metal compound. Thereafter, for the purpose of polycondensation, the oil bath was heated to 140° C. over a period of 30 minutes. One hour after the temperature started rising, the internal temperature of the solution reached 100° C., and then, the solution was heated with stirring for 2 hours (the internal temperature was 100 to 130° C.). During the reaction, IPA, propanol, and water were distilled off. During the heating with stirring, no precipitation occurred in the contents of the flask, and the solution was uniformly transparent.

After completion of the heating, the contents of the flask were cooled to room temperature to obtain a polymetalloxane (A-1) solution. The appearance of the polymetalloxane solution obtained was pale yellow and transparent. The content of the structure of the part bracketed by ( )ₐ in the polymetalloxane was 100 mol %. The solid content concentration of the polymetalloxane (A-1) solution obtained was 39.57 mass %, and the viscosity was 304 cP.

The polymetalloxane (A-1) solution was analyzed by FT-IR. A peak derived from a bond between tripropylene glycol monobutyl ether and zirconium (1095 cm⁻¹) and an absorption peak of Zr—O—Si (968 cm⁻¹) were confirmed. Thus, it was confirmed that the polymetalloxane has a tripropylene glycol monobutyl ether group and a trimethylsiloxy group in a side chain. The weight-average molecular weight (Mw) of the polymetalloxane (A-1) was 253,000 in terms of polystyrene.

The storage stability of the polymetalloxane (A-1) solution was determined as A because the viscosity change rate was less than 10%.

### (Example 2) Polymetalloxane (A-2) Solution

The zirconium compound (Z-1) synthesized in Synthesis Example 3 in an amount of 38.2 g (0.07 mol), 7.87 g (0.03 mol) of di-s-butoxy(trimethylsiloxy)aluminum synthesized in Synthesis Example 2, and 5.0 g of DMIB as a solvent were mixed to obtain a solution 3. In addition, 3.60 g (0.20 mol) of water, 50.0 g of IPA as a water-diluting solvent, and 0.37 g (0.02 mol) of tributylamine as a polymerization catalyst were mixed to obtain a solution 4.

Into a three-necked flask having a volume of 500 mL, the entire amount of the solution 3 was fed, and the flask was immersed in an oil bath at 40° C. The solution was stirred for 30 minutes. Thereafter, the entire amount of the solution 4 was fed into a dropping funnel and then dropped into a flask over 1 hour for the purpose of hydrolysis. During the addition of solution 4, no precipitation occurred in the contents of the flask, and the solution was uniformly pale yellow and transparent. After the addition of the solution 4, the mixture was further stirred for 1 hour to obtain a hydroxy-group-containing metal compound. Thereafter, for the purpose of polycondensation, the oil bath was heated to 140° C. over a period of 30 minutes. One hour after the temperature started rising, the internal temperature of the solution reached 100° C., and then, the solution was heated with stirring for 2 hours (the internal temperature was 100 to 130° C.). During the reaction, IPA, s-butanol, propanol, and water were distilled off. During the heating with stirring, no precipitation occurred in the contents of the flask, and the solution was uniformly transparent.

After completion of the heating, the contents of the flask were cooled to room temperature to obtain a polymetalloxane (A-2) solution. The appearance of the polymetalloxane solution obtained was pale yellow and transparent. The content of the structure of the part bracketed by ( )ₐ in the polymetalloxane was 70 mol %. The solid content concentration of the polymetalloxane (A-2) solution obtained was 44.07 mass %, and the viscosity was 826 cP.

The polymetalloxane (A-2) solution was analyzed by FT-IR. An absorption peak derived from a bond between tripropylene glycol monobutyl ether and zirconium (1095 cm⁻¹), an absorption peak of Zr—O—Si (968 cm⁻¹), and an absorption peak of Al—O—Si (949 cm⁻¹) were confirmed. Thus, it was confirmed that the polymetalloxane has a tripropylene glycol monobutyl ether group and a trimethylsiloxy group in a side chain. The weight-average molecular weight (Mw) of the polymetalloxane (A-2) was 234,000 in terms of polystyrene.

The storage stability of the polymetalloxane (A-2) solution was determined as A because the viscosity change rate was less than 10%.

### (Examples 3 to 5) Polymetalloxane (A-3 to A-5) Solutions

Hydrolysis and polycondensation were performed in the same manner as in Example 2 except that the amounts of the zirconium compound (Z-1) and di-s-butoxy(trimethylsiloxy)aluminum were changed to the amounts in Table 1, to obtain polymetalloxane (A-3 to A-5) solutions. The appearance of each of the polymetalloxane (A-3 to A-5) solutions was pale yellow and transparent. The content, solid content concentration, viscosity, and weight-average molecular weight of the structure of the part bracketed by ( )ₐ in each polymetalloxane were measured, and the storage stability was evaluated. The results are tabulated in Table 2.

### (Comparative Example 1) Polymetalloxane (B-1) Solution

The di-s-butoxy(trimethylsiloxy)aluminum synthesized in Synthesis Example 2 in an amount of 26.2 g and 5.0 g of DMIB as a solvent were mixed to obtain a solution 5. In addition, 3.60 g (0.20 mol) of water, 50.0 g of IPA as a water-diluting solvent, and 0.37 g (0.02 mol) of tributylamine as a polymerization catalyst were mixed to obtain a solution 6.

Into a three-necked flask having a volume of 500 mL, the entire amount of the solution 5 was fed, and the flask was immersed in an oil bath at 40° C. The solution was stirred for 30 minutes. Thereafter, the entire amount of the solution 6 was fed into a dropping funnel and then dropped into a flask over 1 hour for the purpose of hydrolysis. During the addition of solution 6, no precipitation occurred in the contents of the flask, and the solution was uniformly pale yellow and transparent. After the addition of the solution 6, the mixture was further stirred for 1 hour to obtain a hydroxy-group-containing metal compound. Thereafter, for the purpose of polycondensation, the oil bath was heated to 140° C. over a period of 30 minutes. One hour after the temperature started rising, the internal temperature of the solution reached 100° C., and then, the solution was heated with stirring for 2 hours (the internal temperature was 100 to 130° C.). During the reaction, IPA, s-butanol, and water were distilled off. During the heating with stirring, the contents of the flask lost fluidity and turned into a gel.

### (Comparative Example 2) Polymetalloxane (B-2) Solution

Hydrolysis and polycondensation were performed in the same manner as in Comparative Example 1 except that the amount of DMIB mixed as a solvent was changed from 5.0 g to 15.0 g. During the heating with stirring, no precipitation or gelation occurred in the contents of the flask, and the solution was uniformly transparent.

After completion of the heating, the contents of the flask were cooled to room temperature to obtain a polymetalloxane (B-2) solution. The appearance of the polymetalloxane solution obtained was pale yellow and transparent. The solid content concentration of the polymetalloxane (B-2) solution obtained was 46.86 mass %, and the viscosity was 1317 cP.

The polymetalloxane (B-2) solution was analyzed by FT-IR. An absorption peak of Al—O—Si (949 cm⁻¹) was confirmed. Thus, it was confirmed that the polymetalloxane has a trimethylsiloxy group in a side chain. The weight-average molecular weight (Mw) of the polymetalloxane (B-2) was 190,000 in terms of polystyrene.

The storage stability of the polymetalloxane (B-2) solution was determined as C because the viscosity change rate was 50% or more.

### (Comparative Example 3) Polymetalloxane (B-3) Solution

The tripropoxy(trimethylsiloxy)zirconium synthesized in Synthesis Example 1 in an amount of 35.8 g and 5.0 g of DMIB as a solvent were mixed to obtain a solution 7. In addition, 3.60 g (0.20 mol) of water, 50.0 g of IPA as a water-diluting solvent, and 0.37 g (0.02 mol) of tributylamine as a polymerization catalyst were mixed to obtain a solution 8.

Into a three-necked flask having a volume of 500 mL, the entire amount of the solution 7 was fed, and the flask was immersed in an oil bath at 40° C. The solution was stirred for 30 minutes. Thereafter, the entire amount of the solution 8 was fed into a dropping funnel and then dropped into a flask over 1 hour for the purpose of hydrolysis. During the addition of solution 8, no precipitation occurred in the contents of the flask, and the solution was uniformly pale yellow and transparent. After the addition of the solution 8, the mixture was further stirred for 1 hour to obtain a hydroxy-group-containing metal compound. Thereafter, for the purpose of polycondensation, the oil bath was heated to 140° C. over a period of 30 minutes. One hour after the temperature started rising, the internal temperature of the solution reached 100° C., and then, the solution was heated with stirring for 2 hours (the internal temperature was 100 to 130° C.). During the reaction, IPA, s-butanol, and water were distilled off. During the heating with stirring, the contents of the flask lost fluidity and turned into a gel.

### (Comparative Example 4) Polymetalloxane (B-4) Solution

Hydrolysis and polycondensation were performed in the same manner as in Comparative Example 3 except that the amount of DMIB mixed as a solvent was changed from 5.0 g to 15.0 g. During the heating with stirring, no precipitation or gelation occurred in the contents of the flask, and the solution was uniformly transparent.

After completion of the heating, the contents of the flask were cooled to room temperature to obtain a polymetalloxane (B-4) solution. The appearance of the polymetalloxane solution obtained was pale yellow and transparent. The solid content concentration of the polymetalloxane (B-4) solution obtained was 43.84 mass %, and the viscosity was 827 cP.

The polymetalloxane (B-4) solution was analyzed by FT-IR. An absorption peak of Zr—O—Si (968 cm⁻¹) was confirmed. Thus, it was confirmed that the polymetalloxane has a trimethylsiloxy group in a side chain. The weight-average molecular weight (Mw) of the polymetalloxane (B-4) was 280,000 in terms of polystyrene.

The storage stability of the polymetalloxane (B-4) solution was determined as D because the viscosity change rate was 100% or more.

### (Comparative Example 5) Polymetalloxane (B-5) Solution

The tripropoxy(trimethylsiloxy)zirconium synthesized in Synthesis Example 1 in an amount of 17.9 g, 13.1 g (0.05 mol) of the di-s-butoxy(trimethylsiloxy)aluminum synthesized in Synthesis Example 2, and 15.0 g of DMIB as a solvent were mixed to obtain a solution 9. In addition, 3.60 g (0.20 mol) of water, 50.0 g of IPA as a water-diluting solvent, and 0.37 g (0.02 mol) of tributylamine as a polymerization catalyst were mixed to obtain a solution 10.

Into a three-necked flask having a volume of 500 mL, the entire amount of the solution 9 was fed, and the flask was immersed in an oil bath at 40° C. The solution was stirred for 30 minutes. Thereafter, the entire amount of the solution 10 was fed into a dropping funnel and then dropped into a flask over 1 hour for the purpose of hydrolysis. During the addition of solution 10, no precipitation occurred in the contents of the flask, and the solution was uniformly pale yellow and transparent. After the addition of the solution 10, the mixture was further stirred for 1 hour to obtain a hydroxy-group-containing metal compound. Thereafter, for the purpose of polycondensation, the oil bath was heated to 140° C. over a period of 30 minutes. One hour after the temperature started rising, the internal temperature of the solution reached 100° C., and then, the solution was heated with stirring for 2 hours (the internal temperature was 100 to 130° C.). During the reaction, IPA, s-butanol, prooanol, and water were distilled off. During the heating with stirring, no precipitation or gelation occurred in the contents of the flask, and the solution was uniformly transparent.

After completion of the heating, the contents of the flask were cooled to room temperature to obtain a polymetalloxane (B-5) solution. The appearance of the polymetalloxane solution obtained was pale yellow and transparent. The solid content concentration of the polymetalloxane (B-5) solution obtained was 47.63 mass %, and the viscosity was 1785 cP.

The polymetalloxane (B-5) solution was analyzed by FT-IR. An absorption peak of Zr—O—Si (968 cm⁻¹) and an absorption peak of Al—O—Si (949 cm⁻¹) were confirmed. Thus, it was confirmed that the polymetalloxane has a trimethylsiloxy group in a side chain. The weight-average molecular weight (Mw) of the polymetalloxane (B-5) was 218,000 in terms of polystyrene.

The storage stability of the polymetalloxane (B-5) solution was determined as D because the viscosity change rate was 100% or more.

### (Example 6) Polymetalloxane (A-6) Solution

Hydrolysis and polycondensation were performed in the same manner as in Example 1 except that 5.0 g of DMIB mixed as a solvent was not mixed. During the heating with stirring, no precipitation or gelation occurred in the contents of the flask, and the solution was uniformly transparent.

After completion of the heating, the contents of the flask were cooled to room temperature to obtain a polymetalloxane (PM-8) solution. The appearance of the polymetalloxane solution obtained was pale yellow and transparent. Measurement of solid content concentration, viscosity, and weight-average molecular weight, and evaluation of storage stability were performed. The results are tabulated in Table 2.

### (Examples 7 to 9) Polymetalloxane (A-7 to A-9) Solutions

Hydrolysis and polycondensation were performed in the same manner as in Example 2 except that the amounts of the zirconium compound (Z-1) and di-s-butoxy(trimethylsiloxy)aluminum were changed to the amounts in Table 1, and 5.0 g of DMIB mixed as a solvent was not mixed. During the heating with stirring, no precipitation or gelation occurred in the contents of the flask, and the solution was uniformly transparent.

After completion of the heating, the contents of the flask were cooled to room temperature to obtain polymetalloxane (A-7 to A-9) solutions. The appearance of the polymetalloxane solution obtained was pale yellow and transparent. Measurement of solid content concentration, viscosity, and weight-average molecular weight, and evaluation of storage stability were performed. The results are tabulated in Table 2.

### (Examples 10 to 12) Polymetalloxane (A-10 to A-12)

Hydrolysis and polycondensation were performed in the same manner as in Example 3, except that the zirconium compound was changed to the types and amounts listed in Table 1, and the amount of DMIB used as a solvent was changed to the amounts in Table 1. During the heating with stirring, no precipitation or gelation occurred in the contents of the flask, and the solution was uniformly transparent.

After completion of the heating, the contents of the flask were cooled to room temperature to obtain polymetalloxane (A-10 to A-12) solutions. The appearance of the polymetalloxane solution obtained was pale yellow and transparent. The content, solid content concentration, viscosity, and weight-average molecular weight of the structure of the part bracketed by ( )ₐ in each polymetalloxane were measured, and the storage stability was evaluated. The results are tabulated in Table 2.

### (Example 13) Polymetalloxane (A-13)

Hydrolysis and polycondensation were performed in the same manner as in Example 3 except that the amount of water was changed to the amount in Table 1. During the heating with stirring, no precipitation or gelation occurred in the contents of the flask, and the solution was uniformly transparent.

After completion of the heating, the contents of the flask were cooled to room temperature to obtain a polymetalloxane (A-13) solution. The appearance of the polymetalloxane solution obtained was pale yellow and transparent. The content, solid content concentration, viscosity, and weight-average molecular weight of the structure of the part bracketed by ( )ₐ in the polymetalloxane were measured, and the storage stability was evaluated. The results are tabulated in Table 2.

TABLE 1

| | | Polymer solution raw material | | | | | |
|---|---|---|---|---|---|---|---|
| | | Zirconium compound | | Aluminum compound | | | |
| | | | Added | | Added | | Water |
| | | Type | amount | Type | amount | Solvent | Mw. 18.01 |
| Example 1 | Polymetalloxane | Zirconium | 54.6 g | — | — | DMIB | 3.60 g |
| | (A-1) solution | compound (Z-1) | (0.10 mol) | | | 5.0 g | (0.20 mol) |
| Example 2 | Polymetalloxane | Zirconium | 38.2 g | Di-s-butoxy | 7.87 g | DMIB | 3.60 g |
| | (A-2) solution | compound (Z-1) | (0.07 mol) | (trimethylsiloxy) | (0.03 mol) | 5.0 g | (0.20 mol) |
| | | | | aluminum | | | |
| Example 3 | Polymetalloxane | Zirconium | 27.3 g | Di-s-butoxy | 13.1 g | DMIB | 3.60 g |
| | (A-3) solution | compound (Z-1) | (0.05 mol) | (trimethylsiloxy) | (0.05 mol) | 5.0 g | (0.20 mol) |
| | | | | aluminum | | | |
| Example 4 | Polymetalloxane | Zirconium | 16.4 g | Di-s-butoxy | 18.4 g | DMIB | 3.60 g |
| | (A-4) solution | compound (Z-1) | (0.03 mol) | (trimethylsiloxy) | (0.07 mol) | 5.0 g | (0.20 mol) |
| | | | | aluminum | | | |
| Example 5 | Polymetalloxane | Zirconium | 5.46 g | Di-s-butoxy | 23.6 g | DMIB | 3.60 g |
| | (A-5) solution | compound (Z-1) | (0.01 mol) | (trimethylsiloxy) | (0.09 mol) | 5.0 g | (0.20 mol) |
| | | | | aluminum | | | |
| Comparative | Polymetalloxane | — | — | Di-s-butoxy | 26.2 g | DMIB | 3.60 g |
| Example 1 | (B-1) solution | | | (trimethylsiloxy) | (0.10 mol) | 5.0 g | (0.20 mol) |
| | | | | aluminum | | | |
| Comparative | Polymetalloxane | — | — | Di-s-butoxy | 26.2 g | DMIB | 3.60 g |
| Example 2 | (B-2) solution | | | (trimethylsiloxy) | (0.10 mol) | 15.0 g | (0.20 mol) |
| | | | | aluminum | | | |
| Comparative | Polymetalloxane | Tripropoxy | 35.8 g | | | DMIB | 3.60 g |
| Example 3 | (B-3) solution | (trimethylsiloxy) | (0.10 mol) | | | 5.0 g | (0.20 mol) |
| | | zirconium | | | | | |
| Comparative | Polymetalloxane | Tripropoxy | 35.8 g | | | DMIB | 3.60 g |
| Example 4 | (B-4) solution | (trimethylsiloxy) | (0.10 mol) | | | 15.0 g | (0.20 mol) |
| | | zirconium | | | | | |
| Comparative | Polymetalloxane | Tripropoxy | 17.9 g | Di-s-butoxy | 13.1 g | DMIB | 3.60 g |
| Example 5 | (B-5) solution | (trimethylsiloxy) | (0.05 mol) | (trimethylsiloxy) | (0.05 mol) | 15.0 g | (0.20 mol) |
| | | zirconium | | aluminum | | | |
| Example 6 | Polymetalloxane | Zirconium | 54.6 g | — | — | — | 3.60 g |
| | (A-6) solution | compound (Z-1) | (0.10 mol) | | | | (0.20 mol) |
| Example 7 | Polymetalloxane | Zirconium | 54.6 g | Di-s-butoxy | 7.9 g | — | 3.60 g |
| | (A-7) solution | compound (Z-1) | (0.07 mol) | (trimethylsiloxy) | (0.03 mol) | | (0.20 mol) |
| | | | | aluminum | | | |
| Example 8 | Polymetalloxane | Zirconium | 54.6 g | Di-s-butoxy | 13.1 g | — | 3.60 g |
| | (A-8) solution | compound (Z-1) | (0.05 mol) | (trimethylsiloxy) | (0.05 mol) | | (0.20 mol) |
| | | | | aluminum | | | |
| Example 9 | Polymetalloxane | Zirconium | 54.6 g | Di-s-butoxy | 18.4 g | — | 3.60 g |
| | (A-9) solution | compound (Z-1) | (0.03 mol) | (trimethylsiloxy) | (0.07 mol) | | (0.20 mol) |
| | | | | aluminum | | | |
| Example 10 | Polymetalloxane | Zirconium | 21.5 g | Di-s-butoxy | 13.1 g | DMIB | 3.60 g |
| | (A-10) solution | compound (Z-2) | (0.05 mol) | (trimethylsiloxy) | (0.05 mol) | 10.0 g | (0.20 mol) |
| | | | | aluminum | | | |
| Example 11 | Polymetalloxane | Zirconium | 27.3 g | Di-s-butoxy | 13.1 g | DMIB | 3.60 g |
| | (A-11) solution | compound (Z-3) | (0.05 mol) | (trimethylsiloxy) | (0.05 mol) | 8.0 g | (0.20 mol) |
| | | | | aluminum | | | |
| Example 12 | Polymetalloxane | Zirconium | 22.3 g | Di-s-butoxy | 13.1 g | DMIB | 3.60 g |
| | (A-12) solution | compound (Z-4) | (0.05 mol) | (trimethylsiloxy) | (0.05 mol) | 10.0 g | (0.20 mol) |
| | | | | aluminum | | | |
| Example 13 | Polymetalloxane | Zirconium | 27.3 g | Di-s-butoxy | 13.1 g | DMIB | 2.70 g |
| | (A-13) solution | compound (Z-1) | (0.05 mol) | (trimethylsiloxy) | (0.05 mol) | 5.0 g | (0.15 mol) |
| | | | | aluminum | | | |

TABLE 2

| | Polymer properties | | | | | | |
|---|---|---|---|---|---|---|---|
| | | Content of | | Solid content | | Weight-average | |
| | | structure of part | | concentration | Viscosity | molecular | Storage |
| | Appearance | bracketed by( )ₐ | | [mass % ] | [cP] | weight | stability |
| Example 1 | Pale yellow and | 100 | mol % | 39.57% | 304 | 253,000 | A |
| | transparent | | | | | | |
| Example 2 | Pale yellow and | 70 | mol % | 44.07% | 826 | 234,000 | A |
| | transparent | | | | | | |
| Example 3 | Pale yellow and | 50 | mol % | 48.46% | 2156 | 222,000 | A |
| | transparent | | | | | | |
| Example 4 | Pale yellow and | 30 | mol % | 54.83% | 8547 | 209,000 | A |
| | transparent | | | | | | |
| Example 5 | Pale yellow and | 10 | mol % | 64.92% | 73841 | 196,000 | B |
| | transparent | | | | | | |
| Comparative | Gel | — | | — | — | — | — |
| Example 1 | | | | | | | |
| Comparative | Pale yellow and | 0 | mol % | 46.86% | 1317 | 190,000 | C |
| Example 2 | transparent | | | | | | |
| Comparative | Gel | — | | — | — | — | — |
| Example 3 | | | | | | | |
| Comparative | Pale yellow and | 0 | mol % | 43.84% | 827 | 280,000 | D |
| Example 4 | transparent | | | | | | |
| Comparative | Pale yellow and | 0 | mol % | 47.63% | 1785 | 218,000 | D |
| Example 5 | transparent | | | | | | |
| Example 6 | Pale yellow and | 100 | mol % | 44.03% | 864 | 282,000 | A |
| | transparent | | | | | | |
| Example 7 | Pale yellow and | 70 | mol % | 50.37% | 3,525 | 270,000 | A |
| | transparent | | | | | | |
| Example 8 | Pale yellow and | 50 | mol % | 56.87% | 14,602 | 260,000 | A |
| | transparent | | | | | | |
| Example 9 | Pale yellow and | 30 | mol % | 66.98% | 130,777 | 255,000 | A |
| | transparent | | | | | | |
| Example 10 | Pale yellow and | 50 | mol % | 49.65% | 2826 | 227,000 | A |
| | transparent | | | | | | |
| Example 11 | Pale yellow and | 50 | mol % | 48.32% | 2088 | 221,000 | A |
| | transparent | | | | | | |
| Example 12 | Pale yellow and | 50 | mol % | 48.47% | 2161 | 222,000 | B |
| | transparent | | | | | | |
| Example 13 | Pale yellow and | 50 | mol % | 47.76% | 1020 | 4,500 | A |
| | transparent | | | | | | |

### Example 14

(Preparation of Composition)

DIB as a solvent was added to the polymetalloxane (A-3) solution synthesized in Example 3, and the solid content concentration was adjusted to 20 mass %.

(Evaluation of Crack Resistance of Cured Film)

Three 6-inch silicon wafers were prepared. Using these wafers as base plates, the composition obtained in Preparation of Composition described above was subjected to spin coating using a spin coater (1H-360S, manufactured by Mikasa Co., Ltd.) at different rotation speeds for each base plate, and then heated at 100° C. for 5 minutes using a hot plate (SCW-636, manufactured by SCREEN Holdings Co., Ltd.) to form coating films. The coating films obtained by the coating step were heated at 500° C. for 5 minutes using a hot plate (SCW-636 manufactured by SCREEN Holdings Co., Ltd.) to form cured films having film thicknesses of 0.3 μm, 0.5 μm, and 0.7 μm. The film thickness was measured using an optical interference type film thickness meter (Lambda Ace STM602, manufactured by SCREEN Holdings Co., Ltd.).

The crack resistance of the obtained cured films was rated in the following five stages. Rating 4 or above was regarded as acceptable.
5: No crack is observed in optical microscope observation (magnification: 5 times)
4: Cracks are slightly observed in optical microscope observation (magnification: 5 times)
3: Cracks are clearly observed in optical microscope observation (magnification: 5 times)
2: Cracks are slightly observed in normal visual observation
1: Cracks are clearly observed in normal visual observation The results of evaluation of the crack resistance are tabulated in Table 3.

(Carbon Content in Solid Material)

For the cured film having a thickness of 0.5 μm formed, the carbon content in the solid material was measured. The carbon atom content in the solid material was determined by the following method. The cured film was irradiated with an ion beam using Pelletron 3SDH (manufactured by National Electrodtstics Corp.) to obtain a scattered ion energy spectrum. Next, the mass numbers of the collided atoms were examined from the obtained spectrum, and the average atomic number ratios of the cured film were obtained. From the obtained average atomic number ratios, the average atomic number ratio of carbon atoms was selected, which was taken as the carbon atom amount in the solid material. The measurement conditions were as follows: incident ion: 4 He⁺⁺, incident energy: 2300 keV, incident angle: 0 deg, scattering angle: 160 deg, sample current: 8 nA, beam diameter: 2 mmφ, and irradiation amount: 48 μC. The carbon content in the solid material is tabulated in Table 1.

### Comparative Example 6 and Examples 15 to 18

The compositions listed in Table 3 were evaluated in the same manner as in Example 14 by the same method as in Example 14. The evaluation results are tabulated in Table 3.

TABLE 3

| | | | | | Evaluation of crack | | | Carbon atom |
|---|---|---|---|---|---|---|---|---|
| | Composition | | | | resistance of cured film | | | amount in |
| | | | Solid content | Heat | Film | Film | Film | solid |
| | Polymetalloxane | | concentration | treatment | thickness | thickness | thickness | material |
| | solution | Solvent | [mass %] | temperature | 0.3 μm | 0.5 μm | 0.7 μm | [atomic %] |
| Example 14 | Polymetalloxane | DMIB | 20 | 500° C. | 5 | 5 | 5 | 3.9 |
| | (A-3) solution | | | | | | | |
| Comparative | Polymetalloxane | DMIB | 20 | 500° C. | 3 | 1 | 1 | 1.4 |
| Example 6 | (B-5) solution | | | | | | | |
| Example 15 | Polymetalloxane | DMIB | 20 | 500° C. | 5 | 4 | 3 | 2.1 |
| | (A-10) solution | | | | | | | |
| Example 16 | Polymetalloxane | DMIB | 20 | 500° C. | 5 | 5 | 4 | 2.8 |
| | (A-11) solution | | | | | | | |
| Example 17 | Polymetalloxane | DMIB | 20 | 500° C. | 5 | 4 | 3 | 3.6 |
| | (A-12) solution | | | | | | | |
| Example 18 | Polymetalloxane | DMIB | 20 | 500° C. | 5 | 3 | 2 | 6.2 |
| | (A-13) solution | | | | | | | |

1. A polymer comprising, as a main chain, a metal-oxygen-metal bond including a structural unit represented by the following general formula (1): 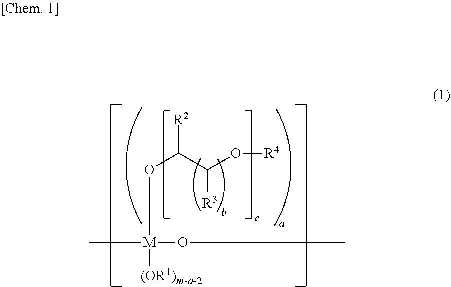
wherein
M represents a metal atom selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi;
R¹ is selected from a hydrogen atom, a C₁-C₈ alkyl group, a C₁-C₈ alkylcarbonyl group, a C₆-C₁₂ aryl group, a C₇-C₁₃ aralkyl group, a (R⁵₃Si—) group, a (R⁶R⁷N—) group, a 4-oxopent-2-en-2-yl group, a C₅-C₁₂ 4-alkoxy-4-oxobuta-2-en-2-yl group, and a C₁₀-C₁₆ 4-aryloxy-4-oxobuta-2-en-2-yl group;
R² and R³ are each independently a hydrogen atom or a C₁-C₈ alkyl group;
R⁴ is a hydrogen atom, a C₁-C₈ alkyl group, or a C₁-C₈ alkylcarbonyl group;
R⁵ is a hydroxy group, a C₁-C₈ alkyl group, a C₅-C₁₂ alicyclic alkyl group, a C₁-C₁₂ alkoxy group, a C₆-C₁₂ aryl group, a C₇-C₁₃ aralkyl group, or a group having a siloxane bond; a plurality of R⁵ may be the same or different;
R⁶ and R⁷ are each independently a hydrogen atom, a C₁-C₈ alkyl group, a C₅-C₁₂ alicyclic alkyl group, a C₆-C₁₂ aryl group, a C₇-C₁₃ aralkyl group, or a C₁-C₁₂ acyl group; R⁶ and R⁷ may be linked via a carbon-carbon saturated bond or a carbon-carbon unsaturated bond to form a ring structure;
m is an integer that represents the valence of the metal atom M;
a is an integer of 1 to (m−2); and
b is an integer of 1 to 6, and c is an integer of 1 to 5.

2. The polymer according to claim 1, wherein c is 2 to 4.

3. The polymer according to claim 1, wherein R⁴ is a C₂-C₆ alkyl group.

4. The polymer according to claim 1, having a weight-average molecular weight of 10,000 or more and 1,000,000 or less.

5. The polymer according to claim 1, wherein M contains one or more metal atoms selected from the group consisting of Al, Ti, Zr, and Sn.

6. A composition comprising the polymer including a metal-oxygen-metal bond as a main chain according to claim 1.

7. A solid material obtained by curing the polymetalloxane according to claim 1.

8. An electronic component comprising the solid material according to claim 7.

9. A fiber composed of the solid material according to claim 7.

10. A method for producing a solid material, the solid material including one or more metal atoms selected from the group consisting of Al, Sc, Ti, V, Cr, Mn, Fe, Co, Ni, Cu, Zn, Ga, Ge, Y, Zr, Nb, Mo, Pd, Ag, In, Sn, Sb, Hf, Ta, W, and Bi, and an oxygen atom, the method comprising a step of heating the polymer including a metal-oxygen-metal bond as a main chain according to claim 1.

11. The method for producing a solid material according to claim 10, wherein the solid material has a carbon atom amount of 10 atomic % or less.

12. The method for producing a solid material according to claim 10, wherein the solid material is a film.

13. The method for producing a solid material according to claim 1, wherein the solid material is for an electronic component.

14. The method for producing a solid material according to claim 10, wherein the solid material is a fiber.

15. A solid material obtained by curing the composition according to claim 6.

16. An electronic component comprising the solid material according to claim 15.

17. A fiber composed of the solid material according to claim 15.

18. A method for producing a solid material, the solid material including one or more metal atoms selected from the group consisting of Al, Sc, Ti, V, Cr, Mn, Fe, Co, Ni, Cu, Zn, Ga, Ge, Y, Zr, Nb, Mo, Pd, Ag, In, Sn, Sb, Hf, Ta, W, and Bi, and an oxygen atom, the method comprising a step of heating the composition according to claim 6.

19. The method for producing a solid material according to claim 18, wherein the solid material has a carbon atom amount of 10 atomic % or less.

20. The method for producing a solid material according to claim 18, wherein the solid material is a film.

21. The method for producing a solid material according to claim 18, wherein the solid material is for an electronic component.

22. The method for producing a solid material according to claim 18, wherein the solid material is a fiber.
